(19) United States
(12) Patent Application Publication
(10) Pub. No.: US 2007/0248636 A1
(43) Pub. Date: Oct. 25, 2007

(54) METHOD FOR ACHIEVING INCREASED EFFECTIVENESS WHEN USING A SYNTHETIC PHEROMONE COMPOSITION TO CAUSE MATING DISRUPTION AMONG INSECT PESTS

(76) Inventors: Bradley HIGBEE, Bakersfield, CA (US); Thomas Larsen, Bend, OR (US); Kristin Ketner, Bend, OR (US)

Correspondence Address: DALINA LAW GROUP, P.C., 7910 IVANHOE AVE. #325, LA JOLLA, CA, 92037, US

(21) Appl. No.: 11/740,214

(22) Filed: Apr. 25, 2007

Related U.S. Application Data
(60) Provisional application No. 60/795,058, filed on Apr. 25, 2006.

(51) Int. Cl. A01N 35/00; A01N 27/00

(52) U.S. Cl. 424/405; 514/762; 514/703

(57) ABSTRACT

A method for achieving increased effectiveness when using a synthetic pheromone composition to cause mating disruption among insect pests such as the navel orangeworm. Makes use of automated dispensers such as aerosol dispensers strategically placed throughout and area of treatment such as an orchard or field and configured to initiate the timed release of an attractant composition such as a synthetic pheromone. In at least one case the attractant composition is a synthetic pheromone comprising (Z,Z)-11, 13-hexadecadienal, and at least one of the following (Z,Z,Z,Z,Z)-3, 6, 9, 12, 15-tricosapentaene, (Z,Z,Z,Z,Z)-3, 6, 9, 12, 15-pentacosapentaene, (Z,Z)-11, 13-hexadecadien-1-ol. The attractant composition is mixed and loaded into the dispensers for distribution in aerosol form. Once the dispensers are loaded to hang in the air during periods of heightened insect pest activity so that mating behavior of the targeted pest population is effectively disrupted. Mixed with stabilizing carrier for prolonged use during growing season.

This application claims benefit of U.S. Provisional Patent Application Ser. No. 60/795,058, filed Apr. 25, 2006, the specification of which is hereby incorporated herein by reference.

### BACKGROUND OF THE INVENTION

1. FIELD OF THE INVENTION

One or more embodiments of the invention relate generally to a method for achieving increased effectiveness when using a synthetic pheromone composition to reduce an insect pest population such as the navel orangeworm by causing mating disruption among members of the population.

2. DESCRIPTION OF THE RELATED ART

Insect pests such as the navel orangeworms, Amyelois transitella, are pests of tree nut crops such as almonds, pistachios, walnuts, and figs. Allowing such pests to breed unfettered results in a significant reduction in crop output and reduces profitability. Current recommendations for management of the navel orangeworm (NOW) focus primarily on cultural practices and, if populations still threaten economic loss, on undesirable application of potentially toxic chemical insecticides as soon as the crop is susceptible and ovipositing females are present. Navel orangeworm larvae attacks most soft-shell cultivars, or nuts with poor seal, feeding inside the nuts on the kernels. Navel orangeworm larvae cannot enter sound nuts before hullsplit so damage occurs after hullsplit and before harvest. Thirty-% damage is not uncommon in late harvested orchards and hence the economic consequences of such a reduction are often significant.

Existing solutions for handling the navel orangeworm population are prohibitively expensive due to inefficiencies present in handling the composition that is used to control the insect population. Hence there is a need for a more efficient and cost-effective approach for controls the targeted pest population. Such a method will now be described by way of example.

### SUMMARY OF THE INVENTION

One or more embodiments of the invention relate generally to a method for achieving increased effectiveness when using a synthetic pheromone composition to cause mating disruption among insect pests such as the navel orangeworm. Methods for implementing effective treatment make use of automated dispensers such as aerosol dispensers strategically placed throughout and area of treatment such as an orchard or field and configured to initiate the timed release of an attractant composition such as a synthetic pheromone. In at least one case the attractant composition is a synthetic pheromone comprising (Z,Z)-11, 13-hexadecadienal, and at least one of the following (Z,Z,Z,Z,Z)-3, 6, 9, 12, 15-tricosapentaene, (Z,Z,Z,Z,Z)-3, 6, 9, 12, 15-pentacosapentaene, (Z,Z)-11, 13-hexadecadien- 1-ol.

The attractant composition is mixed and loaded into the dispensers for distribution in aerosol form. Once the dispensers are loaded to hang in the air during periods of heightened insect pest activity so that mating behavior of the targeted pest population is effectively disrupted. To overcome problems associated with stabilizing the compound against different forms of degradation (oxidation, photo, ultraviolet, etc . . . ) the composition is mixed with a stabilizing carrier for prolonged use during a growing season. The stabilized composition is then placed in a set of strategically placed dispensers for controlled release during periods of heightened insect pest activity. One or more embodiments of the invention the dispensers are spaced throughout the area of treatment (e.g., a field or orchard) in a grid pattern or checkerboard pattern to provide for maximum coverage. In other cases (or in conjunction with a grid or checkerboard pattern) dispensers are placed around the perimeter of the treatment area. In at least one embodiment of the invention the composition within the dispensing devices is placed in an enclosed reservoir for purposes of providing further stabilization against degradation for a seasonal duration. Such stabilization can be achieved, for example, by minimizing exposure of the composition to air, light and/or significant temperature variations. Ultraviolet light, for instance significantly diminishes the compositions effective life. To stabilize the composition from degradation due to oxidation antioxidants can also be added. To further minimize oxidation organic carriers such as heptane and/or acetone can be mixed into the composition. Butylated hydroxytoluene can also be added to the composition.

For instance, the dispensers may have a physical barrier that shields the composition loaded into the dispenser from exposure to light prior to distribution.

In at least one instance the dispensers are configured as aerosol dispensers that distribute the composition into the atmosphere of the area of treatment. The quantity of attractant loaded into each device is carefully minimized to provide economy and efficiency while seeking to avoid replenishment of the pheromone composition during a growing season. When variables such as the positioning, timing and stabilization of the composition are carefully controlled and handled to maximize effectiveness it is feasible to use reduced amounts of the attractant composition. In one embodiment of the invention the dispensers are loaded with a seasonal dose of synthetic pheromone composition that comprises at least one gram per acre per season of the area of treatment. The invention is not limited to such a specific quantity, but it is desirable to minimize the quantity of synthetic pheromone loaded into the device and distributed at the area of treatment to between a range of one to sixteen grams per acre per season. It is possible to control an insect population using other amounts, but when amounts exceed 16 grams the quantities used become cost prohibitive.

To further increase the effectiveness and longevity of the composition the dispensers is configured to time release of the composition with intervals that coincide with a reasonably high level of activity for the target insect while minimizing exposure to light which has a degrading effect on the composition. For instance in one or more embodiments of the invention the dispensers are configured to release the composition at dusk and/or dawn. As the time of such release changes throughout the season the devices automatically adjust so as to perform the release at the appropriate time. Monitoring is performed prior to initiating the population control method described herein and continues throughout the season for purposes of establishing a baseline population density.

Other objects, features and advantages of the present invention will become apparent to those skilled in the art from the detailed description. It is to be understood, however, that the detailed description and specific examples, while indicating one or more preferred embodiments of the invention, are given by way of illustration and not limitation. Many changes and modifications within the scope of the present invention may be made without departing from the spirit thereof, and the invention includes all such modifications and equivalents thereof.

### DESCRIPTION OF THE FIGURES

FIG. 1. Seasonal activity of males in pheromone traps in untreated control and mating disruption treatment plots in pistachio ranches. Treatments include an untreated control (C), the single-component navel orangeworm pheromone (x), and two alternative multi-component formulations (y, z). Symbols and error bas indicate mean and standard error of weekly trap counts (n=9).

FIG. 2. Average and standard error (n=3) of mean numbers of males per traps in pheromone traps in pistachios for the week of 28 April to 25 July (flights 1 & 2), and 1 August to 5 September (flight 3). Treatments include the single-component navel orangeworm pheromone (x), and two alternative multi-component formulations (y, z).

FIG. 3. Proportion of females mated in assays in untreated control and mating disruption plots in almonds and pistachios. Each bar represents a proportion of totals of approximately 500 females recovered from that treatment plot over the season. Treatments include an untreated control (C), the single-component navel orangeworm pheromone (x), and two alternative multi-component formulations (y, z). There were significant differences between all treatments except the two blends in pistachio. Mating was 1.7 times more likely with “x” than with “z”, and two times more likely with “x” treatment than with “y”.

FIG. 4. Weekly mean numbers of navel orangeworm eggs laid on traps in pistachio treatment plots. Treatments include an untreated control (C), the single-component navel orangeworm pheromone (x), and two alternative multi-component formulations (y, z).

FIG. 5. Weekly mean number of navel orangeworm eggs laid in traps in almond treatment plots. Treatments include an untreated control (C), the single-component navel orangeworm pheromone (x), and two alternative multi-component formulations (y, z).

FIG. 6. Percent of Nonpareil almonds infested with navel orangeworm in each study site at harvest. Treatments include an untreated control (C), a chemical treatment (Intrepid), the single-component navel orangeworm pheromone (x), and two alternative multi-component formulations (y, z).

FIG. 7. Percent of all almond pollinator varieties infested with navel orangeworm in each study site at harvest. Treatments include an untreated control (C), a chemical treatment (Intrepid), the single-component navel orangeworm pheromone (x), and two alternative multi-component formulations (y, z).

FIG. 8. Percent of Nonpareil almonds infested with navel orangeworm at harvest (average of study sites). Treatments include an untreated control (C), a chemical treatment (Intrepid), the single-component navel orangeworm pheromone (x), and two alternative multi-component formulations (y, z). Means followed by the same letter are not significantly different at P<0.05, Tukey's HSD.

FIG. 9. Percent of pollinator almonds infested with navel orangeworm at harvest (average of study sites). Treatments include an untreated control (C), a chemical treatment (Intrepid), the single-component navel orangeworm pheromone (x), and two alternative multi-component formulations (y, z). Means followed by the same letter are not significantly different at P<0.05, Tukey's HSD.

### DETAILED DESCRIPTION OF THE INVENTION

The invention that provides a method for mating disruption of an insect pest using automated dispensing apparatus for timed controlled release of the synthetic pheromone composition formulation is described. In the following description, for the purposes of explanation, numerous specific details are set forth to provide a thorough understanding of the invention. It will be apparent, however, to one skilled in the art that the present invention may be practiced without these specific details.

Definitions

As used throughout this document, the term “attracting” generally refers to the action of causing an insect pest, either directly or indirectly, to move in a direction towards the source of stimulus. One in skill in the art will recognize that suitable stimuli include thermostimuli, mechanostimuli, for example, airborne sound waves, or substrate borne pressure waves, electromagnetic stimulus including visual stimulus such as patterns, objects, color, light, and chemical stimulus including pheromones. A chemical stimulus can be an individual compound or a composition, including more than one compound, that either directly or indirectly, causes the targeted insects to move toward the source of stimulus.

As used herein, the term “inhibiting” refers to the action of causing an insect pest, either directly or indirectly, to not move in a direction towards the source of stimulus. One in skill in the art will recognize that suitable stimuli include thermostimuli, mechanostimuli, for example, airborne sound waves, or substrate borne pressure waves, electromagnetic stimulus including visual stimulus such as patterns, objects, color, light, and chemical stimulus including pheromones. A chemical stimulus can be an individual compound or a composition, including more than one compound, that either directly or indirectly, causes the insect to fail to move in a direction toward the source of the stimulus. Useful stimuli include those that also repel, or drive away, insect pests of the present invention.

As used herein, the term “insect pest” refers to any insect that is disruptive or destructive to the growth and development of agricultural crops. Examples of agricultural crops useful in the present invention include, but are not limited to, figs and tree nut crops such as almonds, walnuts, and pistachios. In some embodiments, insect pests of the present invention belong to the family Pyralidae. In other embodiments, insect pests of the present invention belong to the subfamily Phycitinae or Pyralinae. In still other embodiments, insect pests of the present invention include the navel orangeworm, Amyelois transitella, and the meal moth, Pyralisfarinalis (Linnaeus). One of skill in the art will recognize that further insect pests will be useful in the present invention.

As used herein, the term “isolated” refers to a substance that has been separated from one or more substances so as to obtain pure or in a free state. In some embodiments, methods of isolation include crystallization and chromatography. Other methods of isolation will be apparent to one of skill in the art.

As used herein, the term “synthetic pheromone composition” refers to a chemical composition of one or more specific isolated pheromone compounds. Typically, such compounds are produced synthetically and mimic the response of natural pheromones. Pheromones are compounds produced by an animal or insect and serve as a stimulus to other individuals of the same species for one or more behavioral responses. In some embodiments, the behavioral response to the pheromone is attraction. In other embodiments, the species to be influenced is repelled by the pheromone.

As used herein, the term “mating disruption” refers to the release of synthetic pheromone compositions (e.g., using controlled release by automated dispensing apparatus) in sufficient quantities that males are unable to orient to natural source of pheromone, fail to locate females, and reproduction is thus prevented.

As used herein, the term “dispenser” or “dispensing device” refers to an automated device that provides a pheromone reservoir and a controlled release of the content. Examples of the controlled release include, but not limited to, atomize, dispense, diffuse, evaporate, spray, vaporize, or the like. The rate of controlled release may be continuous, periodic, or timed intervals. In one embodiment of the invention the automated dispensing apparatus is an electronically controlled microsprayer or aerosol dispenser (referred to as “mister” and “puffer”, respectively). The exemplary dispenser apparatus allows for controlling the duration and amount of the spray, as well as, the time interval between spraying and which is economical to manufacture and operate and portable and which allows for replacement of an empty container without replacing the entire apparatus.

Formulations and Synthetic Pheromone Compositions

The compounds for the present invention are useful for preparing synthetic pheromone compositions that can be used as attractants or inhibitors of the insect species. One of skill in the art can conveniently use the compounds of the invention in the preparation of synthetic pheromone compositions useful in a variety of contexts.

The synthetic pheromone compositions described herein and used in accordance with one or more embodiments of the invention are useful for attracting, inhibiting or controlling a number of insect pests. As explained in detail below, the compositions are used in at least one case to control a navel orangeworm population. In one or more embodiments, the synthetic pheromone compositions of the present invention are useful for inhibiting the meal moth.

The synthetic pheromone compositions and the compounds useful for preparing synthetic pheromone compositions, and methods of making the synthetic pheromone composition, including the assays for testing the compositions to determine the ability to producing a response in the insects that indicates the presence or absence of a pheromone are described in U.S. patent application Ser. No. [] entitled “Navel Orangeworm Pheromone Composition” which is incorporated herein by reference.

The pheromone compositions used in accordance with one or more embodiments of the invention comprise one or more isolated compounds disclosed herein. An example of a pheromone composition useful in the context of the present invention comprises (Z,Z)-11,13-hexadecadienal. The pheromone composition may further comprise (Z,Z,Z,Z,Z)-3,6,9,12,15-tricosapentaene and/or (Z,Z,Z,Z,Z)-3, 6, 9, 12, 15-pentacosapentaene.

Additional pheromone composition for controlled release by automated dispensing apparatus of the present invention also comprise a member selected from the group consisting of (Z,Z)-11,13-hexadecadien-1-ol, (Z,E)-11,13-hexadecadienal, (E,Z)-11,13-hexadecadienal, (Z)-11-hexadecenal, hexadecanal, (Z,E)-11,13-hexadecadien- 1-ol, (Z)-11-hexadecen-1-ol and methyl hexadecanoate.

Other pheromone compositions for controlled release by automated dispensing apparatus of the present invention comprise (Z,Z)-11,13-hexadecadienal, (Z,Z,Z,Z,Z)-3,6,9,12,15-tricosapntaene, (Z,Z)-11,13-hexadecadienoate, (Z)-13-hexadecenal and ethyl palmitate.

Synthetic pheromone compositions as used in accordance with one or more embodiments of the invention are prone to oxidation and photo-degradation. The present invention increases effectiveness of these compositions by mixing the pheromone composition with a stabilizing carrier that stabilizes the composition by providing among other things UV protection and a reduction in oxidation.

Embodiments of the invention are also able to increase effectiveness of the pheromone composition by putting the composition in a closed housing that provides protection from oxidation and photo-degradation. In certain embodiments, the closed housing is an opaque container that protects the content from exposure of outside air and light. For example, such housing can be an aerosol can. A method of using aerosol can keeps pressurized content of the pheromone composition and also keeps out the outside air and light.

In certain embodiments, an automated dispensing apparatus is configured to depress the valve of an aerosol can, emitting a short pulse of can contents. For this application, the pheromone composition is formulated with a propellant and packaged in a conventional spray can, which protects contents from degradation from light and air. The pheromone composition and optionally with a stabilizing carrier can be applied as an aerosol spray. The controlled release by aerosol sprays can be applied by methods or equipment including an aerosol can with automated dispensing apparatus.

By achieving a longer shelf life through the addition of a stabilizing carrier and/or an enclosed housing, greater efficiency is achieved as a result of have to less frequently replenish the pheromone composition in automated dispensing apparatus due to degradation.

Stabilizing Carrier

In one or more embodiments of the invention, the pheromone compositions retains its essential performance characteristics during application throughout a season by being used in conjunction with a stabilizing carrier that provides for minimal exposure to air, light and/or oxidation. The dispenser is configured to achieve UV and/or photo protection and minimize oxidation, or any combination thereof. A suitable stabilizing carrier is any carrier that effectively dissolves the pheromone composition. In at least one embodiment of the invention the stabilizing carrier comprises a solvent and the stabilizing carrier may further comprise a compound that provides UV protection, anti-oxidation, or any combination thereof. In one embodiment of the invention for example, the stabilizing carrier is a solvent mixture consisting of acetone and heptane, with a UV stabilizer/antioxidant compound consisting of butylated hydroxytoluene (BHT).

Mating Disruption

In one embodiment of the invention a multi-component formulation is used to disrupting mating of the insect pests in conjunction with an automated dispensing device. Release of high and uniform concentrations of the pheromone has been found to be effective because it shuts down the ability of male sensory organs to detect the pheromone. In addition, if the pheromones are released from many source locations, males are attracted to false sources, wasting time and energy. Under these conditions, the likelihood of a male finding a female is reduced. Thus the agricultural crop is protected from infestation of insect pest larvae from the result of mating.

In this case when the desired response is disruption of mating by confusing or inhibiting the insect pests, an effective amount is defined as that quantity of the pheromone composition which permeates the atmosphere such that males are prevented from orienting to and inseminating the females, i.e., disruption of mating, at a rate significantly higher than disruption of mating of males at an untreated location. As with the attractant response, factors such as population density, temperature, wind velocity, and rain will influence the actual number of moths disrupted. The exact dose to use in any particular set of circumstances is determined in at least one embodiment of the invention by dose-response field-testing. The dosage range varies depending upon filed conditions and can, for example, range from approximately one gram per acre per season to sixteen or more grams per acre per season. The lower the effectives dosage the more cost effective it is to control the target insect population.

In one embodiment of the invention crop protection through mating disruption is accomplished by controlled release of the pheromone composition during time period of heightened insect pest activity and lower light exposure (e.g., dusk and/or dawn). To further maximize effectiveness automated dispensing devices are placed in a grid pattern so that maximum permeation of the pheromone compositions is achieved throughout the area of treatment. In at least one embodiment of the invention the grid pattern of automated dispensing apparatus placement provides a maximum coverage of the agricultural crop for mating disruption of insect pests. It is also feasible however to placed the dispensing devices around the periphery of the area of treatment and/or to use a combination of the grid and peripheral approach. The grid however is generally considered to be more effective at reducing the target inspect population.

In one embodiment of the invention the automated dispensing apparatus is programmed to release measured doses of pheromone composition effective in disrupting the mating behavior of insect pests from a period of, for example, evening to dusk when the insect pests are more active during the growing and harvest seasons. Economy is further achieved from not running the automated dispensing apparatus constantly throughout day and night and by controlling the distribution so that it occur during times where the composition is less susceptible to exposure to light.

### EXAMPLE

A number of examples setting forth the materials and method for implementing one or more embodiments of the invention now follows. Readers should note however that these are examples only and that it is within the scope and spirit of the invention to implement the method described using one or more alternative approaches. Materials and Methods

Aerosol Cans. To prepare aerosol cans to be used in accordance with one or more embodiments of the invention the following is added into a clean, dry, stainless steel tank in order by % of final weight (for example, 384 grams per can): heptane 28.4306% and acetone 6%. BHT (butylated hydroytoluene) 0.0067% is added slowly to the tank under medium mixing using air mixer. Once the BHT is completely dissolved, one or more embodiments of the invention slowly add the pheromone composition based on 91.8% purity and 1.0627% by final weight under medium mixing using air mixer. The concentrate is then mixed until homogenous for approximately 20-30 minutes. Embodiments of the invention then contemplate filling each 211×604, 2Q, straight wall aerosol cans painted outside with the concentrate 35.50% and propellant HFC-134A (1,1,1,2-tetrafluoroethane) 64.50% for the final total of 384 grams (100%). The cans can then be crimped with metered valves (40 mg/puff) with buna-p gasket and dip tube and notched at 171 mm.

Mating disruption. In one example implementation of an embodiment of the invention mating disruption treatments were applied in 40-acre treatment blocks in three pistachio and four almond ranches of 640 acres each. The effects of two different multi-component pheromone composition formulations (blend “z” and “y” treatment) of the present invention were compared with the single component formulation of (Z,Z)-11,13-hexadecadienal and an untreated control, and compared these materials with methoxyfenozide (brand name: Intrepid), used in buffer areas surrounding the 40-acre treatment plots.

In the example illustrated here, dispensing devices containing microprocessors were placed at the density of 2 cabinets per acre, suspended at about two-thirds canopy height at approximately 20 m intervals in a grid pattern. The cabinets were loaded with aerosol cans containing either multi-component pheromone composition formulations or single component formulation of ≧90% purity in a carrier. The amount of pheromone and carrier used was calculated to be sufficient to provide pheromone and propellant from when mating disruption was started until 1 October. Mating disruption began on 25-28 Apr. 2005 and ended on 17 Sep. 2005. The cabinets were programmed to propel 0.2 mg of active ingredient every 15 minutes between 6:00 p.m. and 6:00 a.m. Pacific daylight saving time, thus delivering, in principle, 48 mg active ingredient per acre per night for roughly 144 days. However as was stated above the dose of active ingredient varies depending on the implementation between one gram and sixteen or more grams. Moreover increasing the quantity of composition distributed subsequent to identifying a device failure can make up for any equipment failures that might occur. In one embodiment of the invention the composition is dispersed at intervals that automatically adjust to be ideal in terms of maximum insect activity and/or light exposure.

Flight traps. Male prevalence and the ability of males to locate calling females is monitored in one embodiment of the invention using unmated females as a pheromone source. Groups of three females sealed in a mesh bag suspended from the top of a wing trap are one means of performing such monitoring. The effects of pheromone trap heights on male counts can be measured and adjustments made as needed to increase effectiveness.

A target insects population was used purposes of testing one or more embodiments of the invention. Males were identified using the testes, visible as a dark spot through the dorsal cuticle, and discarded. Groups of 100 females were placed in 3.9 liter glass jars with the bottom covered with bran diet to a depth of 2 cm and held at 26° C. 16:8 L:D. Jars were examined on a daily basis, and any moths that had eclosed in the previous scotophase were isolated in transparent plastic vials with screen mesh lids, examined to confirm sex, and held for experiments. Where possible, females were enclosed in mesh bags and placed in the field the first morning after they emerged, and moths were always used within 48 hours of eclosion. When it was necessary to use moths eclosed on two different days, they were grouped so that each bag of three moths contained the same number of 1-day-old and 2-day-old females.

Sixteen flight traps pairs were placed in each treatment and comparison plots. They were arranged in 4×4 grids such that the each lower trap was 1.5 m above the ground and each higher trap was 2.5 m above the ground, ≧100 m from the nearest other adjacent traps, and ≧50 m from the edge of the plot. Each week all traps were examined, mesh bags containing unmated females were replaced, and liners were replaced if they contained moths or were dirty.

Oviposition traps and mating assays. Differences between the treatment and control blocks were assessed using oviposition traps. Mating assays with unmated females were performed in this study.

Results

There were no differences in numbers of NOW males captured in higher than in lower traps in either crop, except for almonds during the first flight. The differences between trap counts in upper and lower counts in almonds during this period varied widely between test locations and, prior to initiation of mating disruption, between treatment plots within ranches. All mating disruption treatments completely shut down both upper and lower flight traps in almonds, indicating that the dispersion devices affect traps in both the lower and upper canopy. In apple orchards in which mating disruption is used against the codling moth, high-dose artificial lures are placed in the upper portion of the canopy for population monitoring. These results suggest that, until a high-dose artificial pheromone lure becomes available for NOW, there is no significant benefit obtained by placing monitoring traps higher in trees although there can be an advantage to varying the height of these monitoring traps in terms of maintenance and/or other reasons.

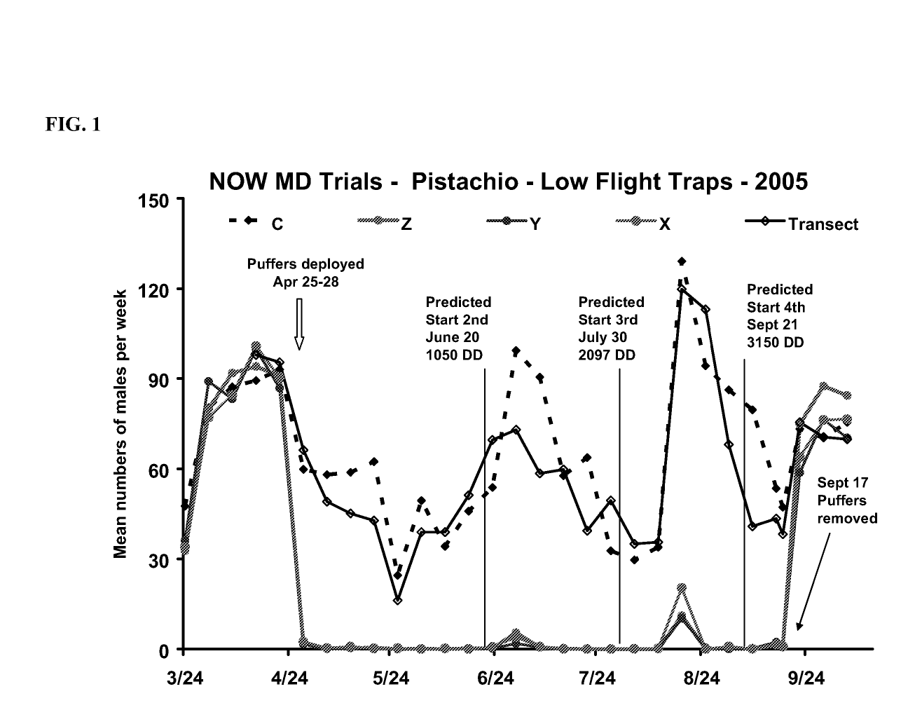

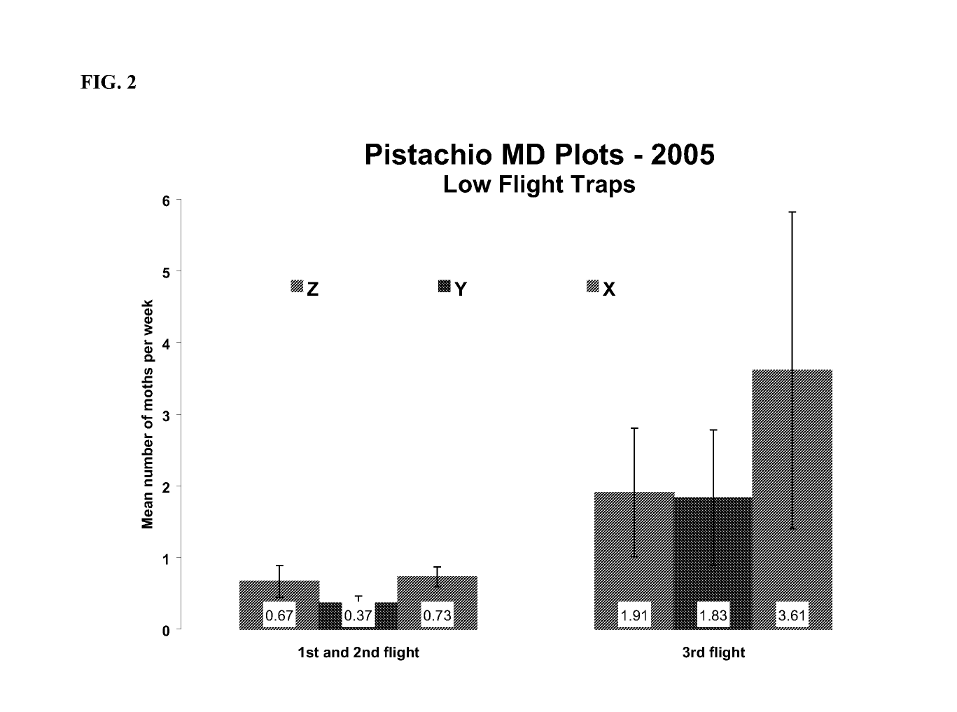

Male trap capture in female baited flight traps was nearly completely shutdown in almond and shutdown in pistachio except for two brief periods corresponding to peaks of activity during the second and third flights (FIG. 1). Pistachio flight trap data were summed by flight in order to reduce the frequency of counts of 0 and facilitate use of parametric statistics. Flights 1 and 2 were pooled, and data were analyzed separately for flight 3 (FIG. 2). Differences between the control and the treatment were significant (P<0.01) for both intervals, whereas that between the mating disruption treatments was not (FIG. 1). However, where there are numerical differences among the mating disruption treatments, the tendency is for the single component treatment (x) to have higher counts.

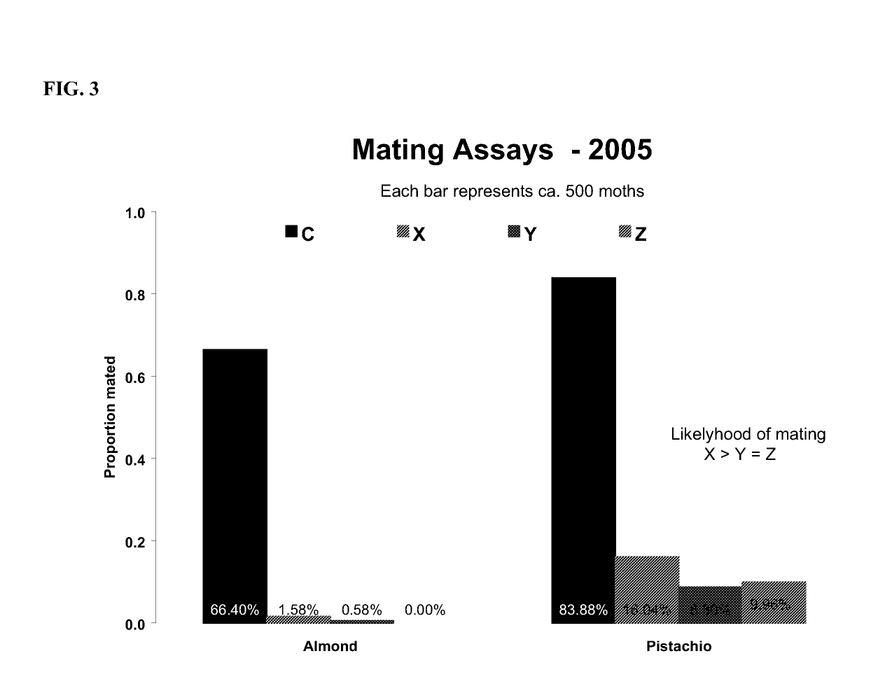

Mating of females in the assays, like the male counts in pheromone baited flight traps, was effectively shut down in all almond plots. Of the 406 females in control plots recovered from assays in almonds over the season, 250 (59%) were mated. In the almond treatment plots, 3 out of 400 females recovered were mated in the “x” treatment, and 0 out of 406 and 1 out of 414 were recovered from almond plots that received the blend “z”and blend “y” treatments. In pistachios 85% were mated out of the 406 females recovered from control plots, and 65 out of 430, 41 out of 401, and 26 out of 417 were mated in the x, z, and y treatments, respectively. In the pistachios both the treatment and ranch effects were highly significant (P<0.0001), and there were significant differences between proportions of females mated in each of the mating disruption treatments (FIG. 3).

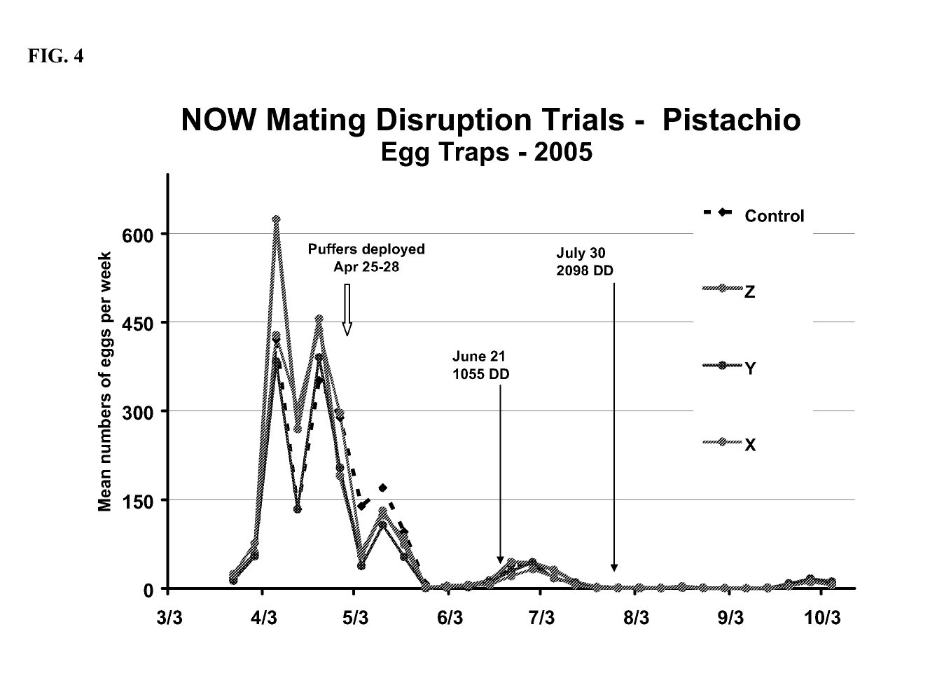

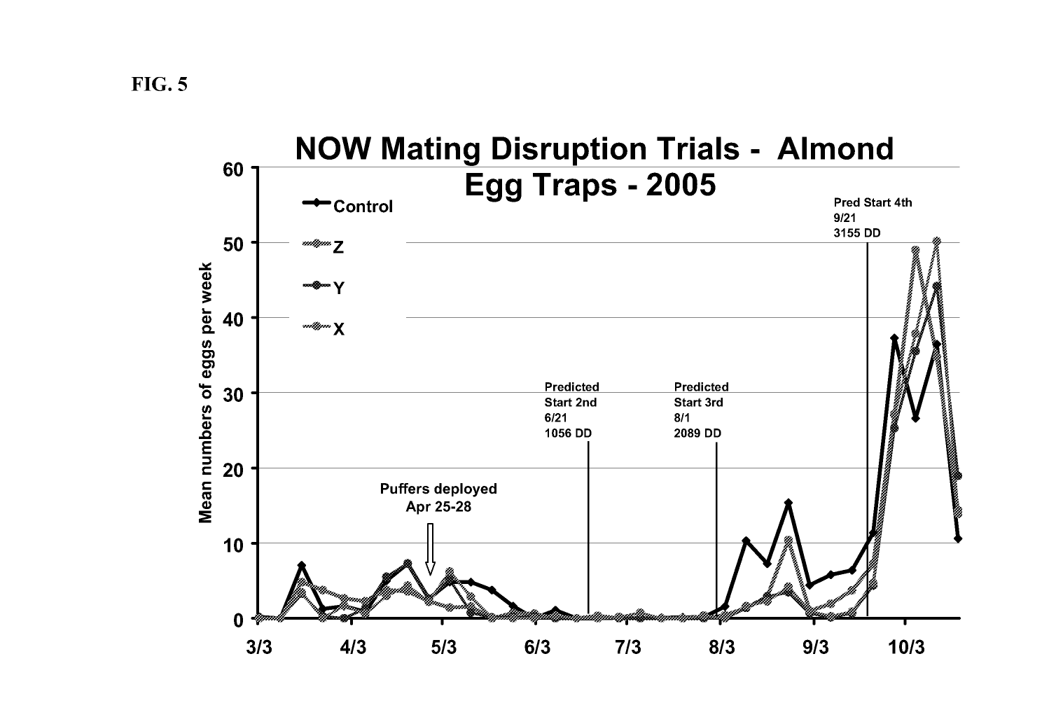

The mating disruption treatments had a greater impact on egg counts on oviposition traps in almonds than in pistachios (FIGS. 4, and 5). In the first flight in pistachios the mean of trap counts in control plots were highest and significantly greater than the means in at least some of the mating disruption plots in all three ranches. However, in the second flight in pistachios the egg counts were numerically higher in some mating disruption treatment plots than the controls in two ranches, and there were no significant differences among treatment plots in the third. These observations suggest that females in the second flight may have dispersed more widely than those in the latter portion of the first flight. Among the almond ranches with low NOW abundance, the overall mean was greater in the untreated control than the treatment plots. In all of the almond ranches, most of the counts on egg traps came after the Nonpareil harvest.

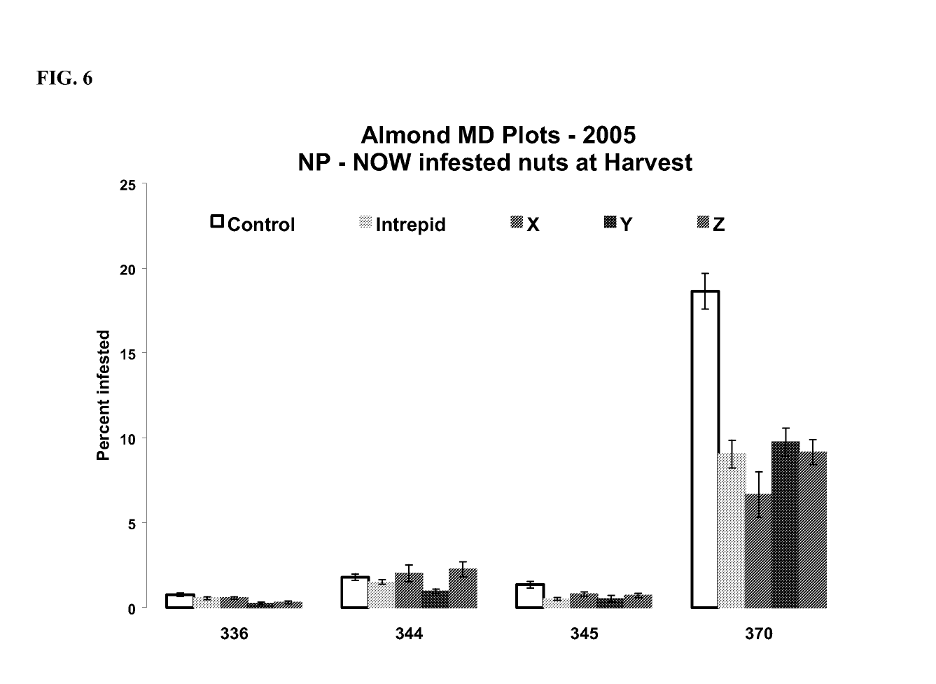

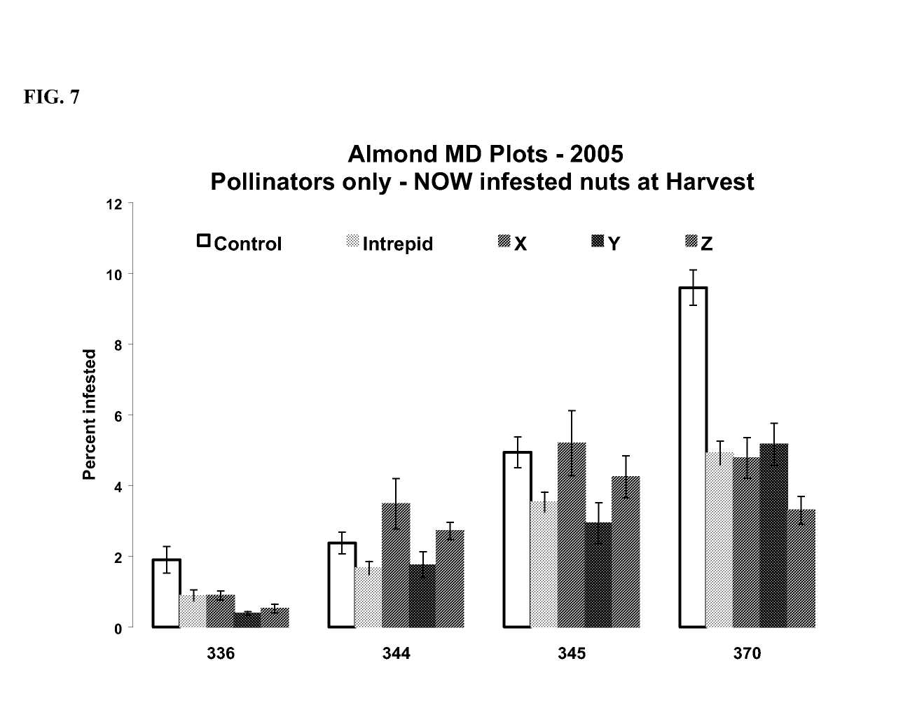

Harvest damage was significantly greater in the untreated control plot than in some of the mating disruption treatment plots in two of the three ranches with low NOW abundance, and in the ranch with high NOW abundance NOW damage was significantly lower than that in the untreated control in all treatment plots and in all buffer areas treated with Intrepid (FIGS. 6 and 7). Generally the Intrepid-treated buffer had lower NOW damage than the adjacent treatment plot when this plot received the untreated control, but similar damage when the adjacent treatment plot received one of the mating disruption treatments. In the low abundance ranches only mating disruption plots treated with the newer multi-component compounds had significantly lower damage than the untreated control. In testing with the old single component compound in previous years we have not seen differences between treatment and untreated control plots when damage was low in the untreated controls. It is also interesting to note that, among the almond ranches with low NOW abundance, the one in which treatment differences are not noted is also the one that was harvested latest.

Discussion

In one embodiment mating disruption against the navel orangeworm was measured in 40-acre treatment blocks in three pistachio and four almond ranches of 640 acres each. An objective during these measurements was to take advantage of the higher NOW abundance in pistachios to compare the effects of a multi-component mating disruption formulations with the single component formulation on trap shutdown and mating, and to compare the effects on NOW damage to Nonpareil almonds of the mating disruption treatments and Intrepid applied to adjacent buffer regions to untreated control plots. Our findings in implementing one or more embodiments of the invention include:

1. In almonds, both the older single component and newer multiple component NOW mating disruption compounds resulted in near-complete shutdown of male capture in pheromone traps baited with unmated females and mating of females in mating assays.

2. In pistachios, where NOW abundance was higher, the proportion of females mated in untreated control plots ranged from 73 to 92%, whereas those recovered from mating disruption treatment plots ranged from 4 to 19%. There was a significant difference in proportion of females mated between each of the treatments; i.e., both of the multiple component formulations were more effective than the single component formulation.

3. The effect of mating disruption treatments on egg counts in oviposition traps was more variable, with reduction seen more in third flight than in first in almonds, and more in first flight than in second in pistachios. Hence the probability of a mated and fecund female dispersing up 200 yards depends on the crop examined and the stage of development of that crop, as well as the abundance of NOW in adjacent areas.

4. Compared with the untreated control plot, all mating disruption treatments significantly reduced NOW damage to Nonpareil almonds in a ranch with high activity (i.e., 18% damage in untreated controls). In addition, significant reduction of damage was seen in two of three almond ranches with low NOW activity (0.7-1.8% damage in untreated controls). In the low NOW activity orchards, significant reduction was seen only associated with treatment plots receiving the multiple component formulations. Damage reduction in low NOW pressure sites was not seen.

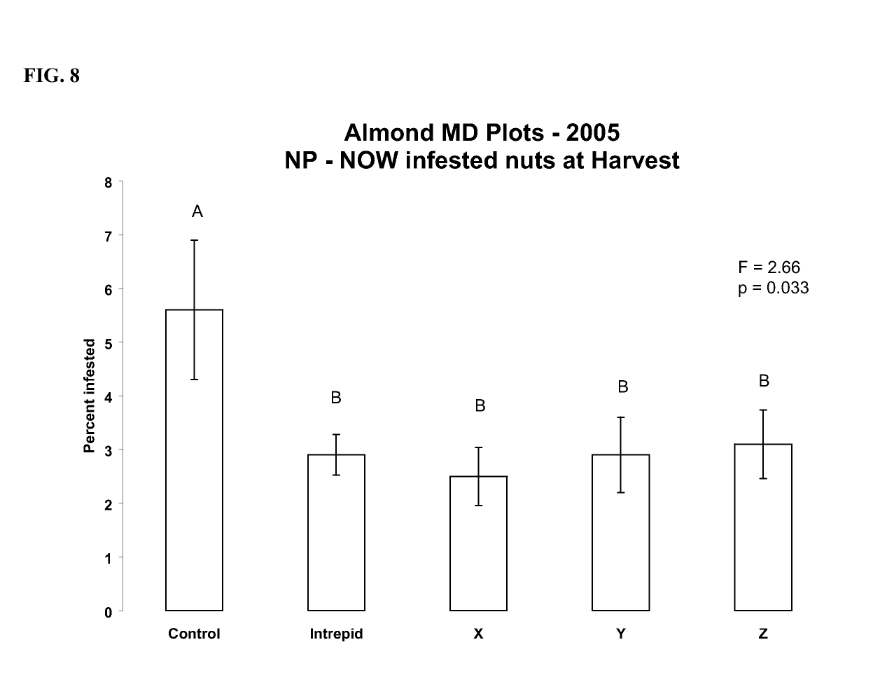

5. The Intrepid treated buffer had significantly less damage than the adjacent control plot in the high damage almond ranch. There was a non-significant trend of lower damage in the Intrepid-treated buffer compared to the adjacent control plot in two of three almond ranches with low NOW damage. Generally NOW damage was similar between Intrepid-treated buffer areas and adjacent mating disruption treatment plots (FIG. 8).

6. There was no significant difference in count between high and low traps in pistachios. Such differences were found in almonds in some situations, but varied greatly with location and season.

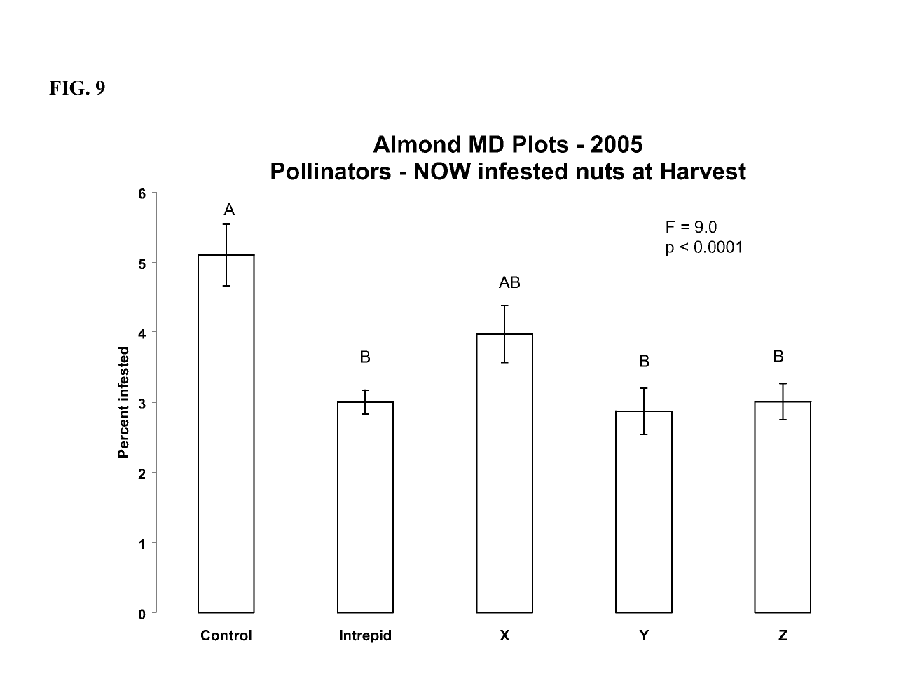

7. All mating disruption treatments reduced NOW damage compared to control plots in pollinator varieties (FIG. 9).

What is claimed is:

1. A method for achieving increased effectiveness when using a synthetic pheromone composition to cause mating disruption among insect pests comprising:
obtaining a synthetic pheromone composition comprising (Z,Z)-11,13-hexadecadienal, and at least one of the following (Z,Z,Z,Z,Z)-3,6,9,12,15-tricosapentaene, (Z,Z,Z,Z,Z)-3,6,9,12,15-pentacosapentaene, (Z,Z)-11,13-hexadecadien-1-ol;
positioning a plurality of dispensing devices throughout an area of treatment where said plurality of dispensing devices each comprise a seasonal dose of said synthetic pheromone composition, said plurality of dispensing devices being configured to perform controlled release of said composition and having an enclosed housing adapted to stabilize said composition from degradation for a seasonal duration; and
timing said controlled release of said synthetic pheromone composition to occur at intervals that coincide with periods of high activity for said insect pest.

2. The method of claim 1 wherein said plurality of dispensing devices are placed around the perimeter of said area of treatment.

3. The method of claim 1 wherein said plurality of dispensing devices are arranged in a grid like pattern throughout said area of treatment.

4. The method of claim 1 wherein said plurality of dispensing devices are arranged in a checkerboard like pattern throughout said area of treatment.

5. The method of claim 1 wherein said housing configured to stabilize said synthetic pheromone composition from degradation comprises a physical barrier that shields said synthetic pheromone composition from exposure to light.

6. The method of claim 3 wherein said plurality of dispensing devices comprises an aerosol dispenser for dispensing said synthetic pheromone composition into the atmosphere of said area of treatment.

7. The method of claim 1 wherein said housing configured to stabilize said synthetic pheromone composition from degradation is configured to minimize the exposure of said pheromone composition to the air outside of said housing.

8. The method of claim 1 wherein said synthetic pheromone composition further comprises antioxidants for purposes of stabilizing said composition.

9. The method of claim 1 wherein said degradation for a seasonal duration comprises oxidative degradation.

10. The method of claim 1 wherein said degradation for a seasonal duration comprises photo-degradation.

11. The method of claim 1 wherein said degradation for a seasonal duration comprises ultraviolet degradation.

12. The method of claim 1 wherein said seasonal dose of said synthetic pheromone composition comprises at least 1 gram per acre per season of said area of treatment.

13. The method of claim 1 wherein said seasonal dose of said synthetic pheromone composition comprises between 1 gram to 16 grams per acre per season of said area of treatment.

14. The method of claim 1 wherein said controlled release of said synthetic pheromone composition occurs at intervals coinciding with reduced light exposure.

15. The method of claim 8 wherein said intervals coinciding with said reduced light exposure is dusk.

16. The method of claim 8 wherein said intervals coinciding with said reduced light exposure is dawn.

17. The method of claim 8 wherein said intervals coinciding with said reduced light exposure is dusk and dawn.

18. The method of claim 1 wherein said insect pest is monitored to established a baseline on population density.

19. The method of claim 1 wherein said insect pests comprises navel orangeworms.

20. The method of claim 1 wherein said synthetic pheromone composition further comprises an organic carrier of heptane to minimize oxidation.

21. The method of claim 1 wherein said synthetic pheromone composition further comprises an organic carrier of acetone to minimize oxidation.

22. The method of claim 1 wherein said synthetic pheromone composition further comprises an organic carrier of heptane, acetone and butylated hydroxytoluene to minimize oxidation.

23. A method for achieving increased effectiveness when using a synthetic pheromone composition to cause mating disruption among navel orangeworm pests comprising:
obtaining a synthetic pheromone composition comprising (Z,Z)-11,13-hexadecadienal, and at least one of the following (Z,Z,Z,Z,Z)-3,6,9,12,15-tricosapentaene, (Z,Z,Z,Z,Z)-3,6,9,12,15-pentacosapentaene, (Z,Z)-11,13-hexadecadien-1-ol; positioning a plurality of dispensing devices throughout an orchard where said plurality of dispensing devices each comprise a seasonal dose of said synthetic pheromone composition, said plurality of dispensing devices being configured to perform controlled release of said composition and having an enclosed housing adapted to stabilize said composition from degradation for a seasonal duration; and
timing said controlled release of said synthetic pheromone composition to occur throughout said orchard at intervals that coincide with periods of high activity for said navel orangeworm pests.
